(19) United States
(12) Patent Application Publication
(10) Pub. No.: US 2014/0189336 A1
(43) Pub. Date: Jul. 3, 2014

(54) METHODS AND APPARATUS TO SUPPORT AUTHENTICATED VARIABLES

(71) Applicants: Miguel Ballesteros, Roseville, CA (US); Vincent Zimmer, Federal Way, WA (US)

(72) Inventors: Miguel Ballesteros, Roseville, CA (US); Vincent Zimmer, Federal Way, WA (US)

(21) Appl. No.: 13/729,307

(22) Filed: Dec. 28, 2012

(51) Int. Cl. G06F 9/44

(52) U.S. Cl. CPC G06F 9/4401
USPC 713/2

(57) ABSTRACT

Methods and apparatus to support authenticated variables are disclosed. An example method includes, in response to an update request directed to an authenticated variable of a computing platform and received during a second stage of a first instance of a booting process, the booting process including a first stage and the second stage, restricting the update request from accessing the authenticated variable during the second stage of the first instance of the booting process and storing the update request in a queue.

### FIELD OF THE DISCLOSURE

This disclosure relates generally to computing platforms and, more particularly, to methods and apparatus to support authenticated variables.

### BACKGROUND

The Unified Extensible Firmware Interface (UEFI) specification facilitates interaction between an operating system (OS) of a computing platform and firmware of the computing platform. Among other services, the UEFI specification provides a secure boot for the computing platform.

### BRIEF DESCRIPTION OF THE DRAWINGS

FIG. 1 is a block diagram of an example computing platform including an example system controller unit constructed in accordance with the teachings of this disclosure.

FIG. 2 is a first communication diagram representative of access controls implemented by the example system controller unit of FIG. 1 during a first stage of the example computing platform of FIG. 1.

FIG. 3 is a second communication diagram representative of access controls implemented by the example system controller unit of FIG. 1 during a second stage of the example computing platform of FIG. 1.

FIG. 4 is a third communication diagram representative of access controls implemented by the example system controller unit of FIG. 1 during a third stage of the example computing platform of FIG. 1.

FIGS. 5-7 are flowcharts representative of example machine readable instructions that may be executed to implement the example system controller unit of FIG. 1.

FIG. 8 is a block diagram of an example processing system capable of executing the example machine readable instructions of FIGS. 5, 6 and/or 7 to implement the example system controller unit of FIG. 1.

### DETAILED DESCRIPTION

A computing platform on which a Unified Extensible Firmware Interface (UEFI) has been implemented may utilize security procedures defined in the UEFI specification, such as a UEFI Secure Boot. To provide the security procedures, the UEFI specification defines and manages trusted databases, such as the Platform Key (PK), Key Enrollment Key (KEK) database and the Allowed/Disallowed Signature databases (db/dbx). UEFI variables associated with the trusted databases and/or other UEFI data structures associated with UEFI security procedures are referred to in the UEFI specification as authenticated variables or secure variables. While the UEFI specification also defines regular variables that can be updated without verification of authenticity, updates to the authenticated variables are required to be authenticated before a corresponding change can be made. The UEFI specification defines verification procedures including, for example, digital certificates and/or hash algorithms to authenticate a requested update to an authenticated variable and/or to authenticate the requester of the update (e.g., a component of the computing platform that generated the update request). In other words, the UEFI specification requires a verification of a signature associated with an update request before the update can be executed. As with many other authentication procedures, it is desirable to perform the signature verification of update requests for UEFI authenticated variables in isolation from the operating system (OS) of the computing platform to decrease the likelihood of (e.g., avoid) a breach of security associated with vulnerability of the software of the OS).

Large core computing platforms typically include a sequestered mode of execution, such as System Management Mode (SMM), that can be utilized to authenticate a requested update in isolation from the OS of the computing platform. Such a mode is advantageous as it performs the authentication without exposing root level privilege systems to risk. That is, such large core computing platforms have a built-in capability of executing programs or routines at different privilege levels (e.g., levels enforced by an SMM), some of which enable authentication of update requests (e.g., requests to update an authenticated variable) in a runtime environment in isolation from the OS. In addition to or in lieu of the built-in SMM capabilities, large core computing platforms can install one or more drivers to implement a sequestered mode of execution capable of securely authenticating, for example, digital signatures associated with write requests and/or other types of update commands.

However, some computing platforms do not include a sequestered mode of execution in which certain procedures can be performed in isolation from the OS. For example, a small core computing platform, such as a System on Chip (SOC) small core computing platform (e.g., Intel's Cloverview (CLV) platform for tablets and other mobile devices such as non-Intel RISC-based SOC's) may not include an SMM capability. Additionally or alternatively, components that provide isolation from the OS (e.g., an isolated co-processor, such as Intel's Chaabi processor in a SOC) may be overloaded and/or otherwise unable to perform certain verification procedure.

Example methods, apparatus, and articles of manufacture disclosed herein enable support for authenticated variables, such as UEFI authenticated variables, on computing platforms that lack a sequestered mode of execution in which updates to such variables can be verified in isolation from an OS. For example, an OS (e.g., Windows 8®) and/or an entity associated with the OS (e.g., Microsoft®) may require computing platforms on which the OS is installed to support a UEFI Secure Boot procedure. However, as described above, some computing hardware architectures may not support, for example, an SMM that is typically used to provide the isolation from the OS during signature verification. To enable such computing platforms to support authenticated variables (e.g., UEFI authenticated variables), examples disclosed herein defer processing of update requests associated with authenticated variables received during certain platform stages (e.g., a runtime environment and/or a portion of a boot cycle not isolated from the OS) until the computing platform enters a platform stage that is isolated from the OS. To store and manage the deferred update requests, examples disclosed herein implement an authenticated variable queue in a portion of flash memory utilized during the pre-boot environment. When an update request (e.g., a write request) for an authenticated variable is received in stages of the computing platform not isolated from the OS (e.g., during the runtime environment and/or a portion of a boot cycle), examples disclosed herein redirect the update request to the authenticated variable queue of the flash memory. Further, examples disclosed herein restrict processing of the update request during the stages not isolated from the OS. Instead, examples disclosed herein process the update request queued in the flash memory during a subsequently entered pre-boot environment (e.g., after a restart, after a standby mode, etc.) in the flash memory via firmware of the pre-boot environment, which is isolated from the OS. While in the isolated pre-boot environment, examples disclosed herein utilize the firmware to determine whether the queued update requests are authentically signed and, if so, update the corresponding authenticated variables. As described above, verifying the authenticity without isolation from the OS involves exposure to potential security breaches. Thus, by processing the update requests in the flash memory via firmware of the pre-boot environment in isolation from the OS, examples disclosed herein provide a solution for supporting authenticated variables, such as UEFI authenticated variables, in computing platforms otherwise lacking support for securely updating the authenticated variables.

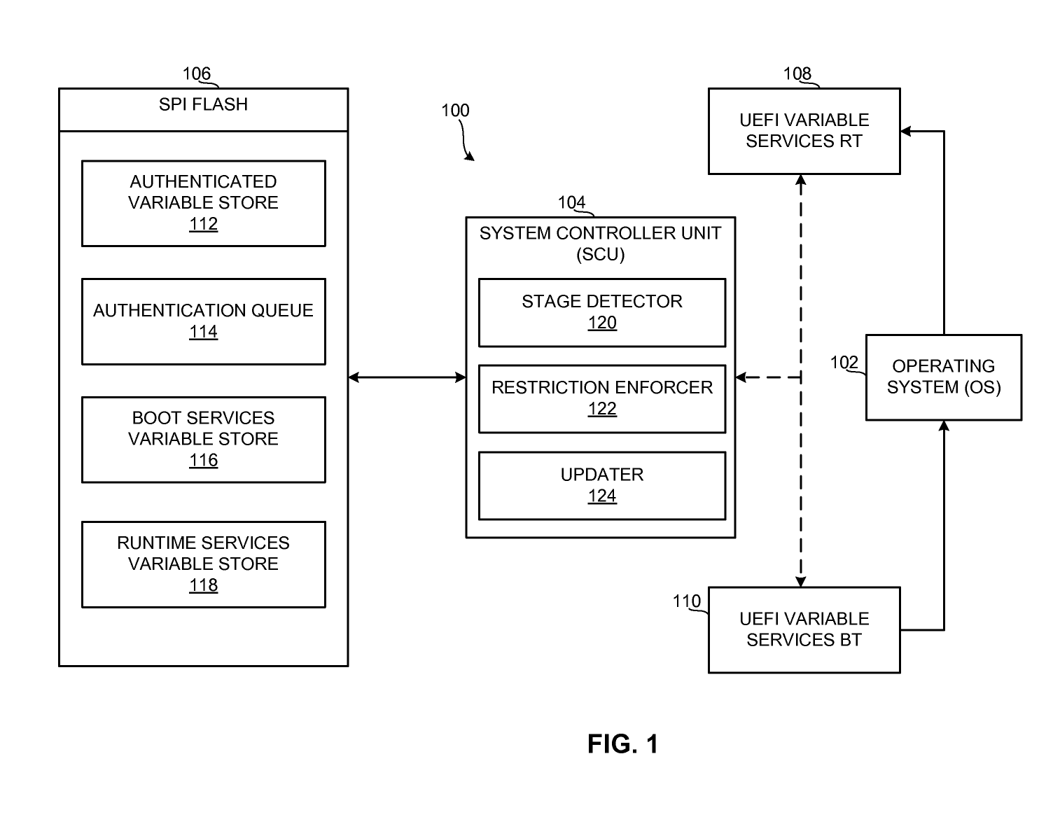

FIG. 1 illustrates an example computing platform 100 in which example methods, apparatus, and/or articles of manufacture disclosed herein can be implemented. In the illustrated example, the computing platform 100 is implemented by a System on Chip (SOC) of a small core system, such as a tablet platform or a mobile phone platform. The example computing platform 100 of FIG. 1 does not employ an SMM to provide isolation from an operating system (OS) 102 in connection with, for example, signature verification for an authenticated variable (e.g., a UEFI authenticated variable). To provide support for security measures that require verification of signatures in isolation from the OS 102, the example computing platform 100 includes a system controller unit (SCU) 104 and flash memory 106. The flash memory 106 of the illustrated example is divided into four (4) partitions. In the illustrated example, the SCU 104 is implemented by firmware associated with a pre-boot environment. The example flash memory 106 is implemented by serial peripheral interface (SPI) flash memory. However, the example SCU 104 can utilize any suitable type of non-volatile memory accessible in the pre-boot environment.

The example computing platform 100 of FIG. 1 includes UEFI runtime variable services 108 and UEFI boot variable services 110. The example UEFI runtime variable services 108 and the UEFI boot variable services 110 provide interfaces between the OS 102 and firmware of the computing platform 100, such as the firmware associated with a pre-boot environment. In particular, the UEFI variable services 108 and 110 define and manage a plurality of variable tables relied on by the OS 102. For example, the UEFI boot variable services 110 assist the OS 102 in securely launching the kernel of the OS 102 and/or one or more device drivers. Additionally, the UEFI runtime variable services 108 facilitate interactions between the OS 102 and, for example, a system clock during execution of the runtime environment. Further, the UEFI variable services 108, 110 shield the OS 102 from, for example, hardware changes and potential conflicts associated with hardware changes. Details of the UEFI variable services 108, 110 and other aspects of the UEFI specification are found at the current version of the UEFI specification (as currently found at www.uefi.org).

The example flash memory 106 of FIG. 1 is divided into an authenticated variable store 112, an authentication queue 114, a boot services variable store 116, and a runtime services variable store 118. Individual ones of the UEFI variables utilized by the example computing platform 100 are stored in the appropriate partition 112-118 of the flash memory 106. For example, the regular UEFI variables (e.g., variables not requiring signature verification before being updated) utilized by the UEFI runtime variable services 108 are stored in the runtime services variable store 118. The runtime services variable store 118 is accessible to the UEFI runtime variable services 108 via the example SCU 104. The regular UEFI variables (e.g., variables not requiring signature verification before being updated) utilized by the UEFI boot variable services 110 are stored in the boot services variable store 116. The boot variable services 110 is accessible to the UEFI boot variable services 110 via the example SCU 104. The UEFI authenticated variables (e.g., variables requiring signature verification before being updated) utilized by the UEFI runtime variable services 108, the UEFI boot variable services 110, and/or any other UEFI service are stored in the authenticated variable store 112. As described in detail below, the example authentication queue 114 of FIG. 1 stores update requests received during certain stages of the computing platform 100 (e.g., a runtime environment and/or a portion of a boot cycle immediately preceding a transfer from the pre-boot environment to the runtime environment) in connection with the authenticated variables of the authenticated variable store 112. Further, as described in detail below, the update requests redirected to the example authentication queue 114 of FIG. 1 are restricted from being processed until a subsequent boot cycle (e.g., a boot cycle entered by the computing platform 100 after the stage during which the queued update requests were received) such that the update requests are processed in a pre-boot environment, in isolation from the OS 102.

The example SCU 104 of FIG. 1 restricts access to the different partitions 112-118 of the flash memory 106 depending on a current stage of the example computing platform 100. To determine a current stage of the example computing platform 100, the example SCU 104 of FIG. 1 includes a stage detector 120. The example stage detector 120 of FIG. 1 identifies which components of the computing platform 100 are active and/or determines which component(s) have control of the example computing platform 100. For example, when the OS 102 has been fully initiated and has control of the computing platform 100 (e.g., control of peripheral devices and a processor), the example stage detector 120 determines that the computing platform 100 is in a runtime environment. In contrast, when a BIOS and/or firmware associated with the UEFI has control over the example computing platform 100, the example stage detector 120 determines that the computing platform 100 is in a pre-boot environment or stage. In the illustrated example of FIG. 1, the pre-boot environment includes two stages that are treated differently by the example SCU 104 of FIG. 1. The two pre-boot stages detected by the example stage detector 120 are divided by issuance of an ExitPmAuth or End-of-Dxe event (from the PI1.2.1 specification, which can be found at www.uefi.org) indication. In the illustrated example, ExitPmAuth corresponds to an authorization to exit a privileged mode. Thus, the example stage detector 120 of FIG. 1 determines that the computing platform 100 is in the first pre-boot stage before issuance of the ExitPmAuth indication. Further, the example stage detector 120 of FIG. 1 determines that the computing platform 100 is in the second pre-boot stage after issuance of the ExitPmAuth indication. Thus, the first pre-boot stage of the example computing platform 100 of FIG. 1 is referred to herein as the Pre-ExitPmAuth stage. The second pre-boot stage of the example computing platform 100 of FIG. 1 is referred to herein as the Post ExitPmAuth stage. In the illustrated example, the Pre-ExitPmAuth stage exhibits isolation from the OS 102, but the Post ExitPmAuth stage does not. As described in detail below, update requests received during the Post ExitPmAuth and the runtime environment are queued for processing during the Pre-ExitPmAuth stage, which enjoys isolation from the OS 102.

The example stage detector 120 of FIG. 1 maintains a stage indicator representative of a current stage of the computing platform 100. For example, when the computing platform 100 is initiated (e.g., powered up from a powered down state), the example computing platform 100 enters the Pre-ExitPmAuth stage and the example stage detector 120 of FIG. 1 sets a Pre-ExitPmAuth indicator. In response to issuance of an ExitPmAuth indication, the example computing platform 100 enters the Post ExitPmAuth stage and the example stage detector 120 of FIG. 1 sets a Post ExitPmAuth indicator. When the computing platform 100 has been fully booted (e.g., when the computing platform 100 has exited boot services), the example stage detector 120 of FIG. 1 sets a runtime indicator. From runtime, the example computing platform 100 may enter a plurality of states that require at least a partially reboot such as, for example, a powered down state, a sleep state, or a standby state (e.g., Windows 8® Connected Standby). As such, the example stage detector 120 of FIG. 1 tracks the computing platform 100 progressing through the different stages.

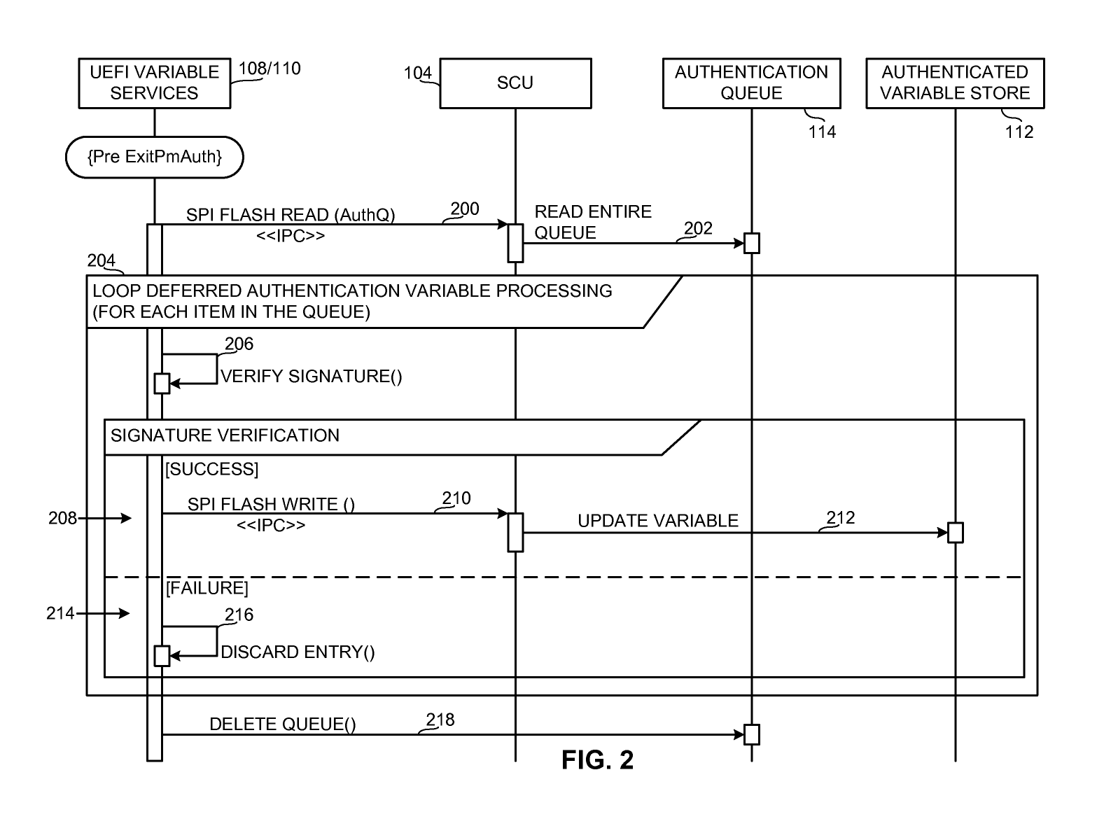

The example SCU 104 of FIG. 1 includes a restriction enforcer 122 to provide different degrees of access to different ones of the partitions 112-118 of the flash memory 106 depending on the detected stage of the computing platform 100. In particular, the example restriction enforcer 122 of FIG. 1 provides read/write/delete access to the authenticated variable store 112 during the Pre-ExitPmAuth stage, read-only access to the authenticated variable store 112 during the Post ExitPmAuth stage, and read-only access to the authenticated variable store 112 during runtime. The example restriction enforcer 122 of FIG. 1 provides read/write/delete access to the boot services variable store 116 during the Pre-ExitPmAuth stage, read/write/delete access to the boot services variable store 116 during the Post ExitPmAuth stage, and read-only access to the boot services variable store 116 during runtime. The example restriction enforcer 122 of FIG. 1 provides read/write/delete access to the runtime services variable store 118 during the Pre-ExitPmAuth stage, the Post ExitPmAuth stage and during runtime. The example restriction enforcer 122 of FIG. 1 and the different accesses provided thereby are described in greater detail below in connection with FIGS. 2-4.

The example SCU 104 of FIG. 1 includes an updater 124 to process the update requests stored in the example authentication queue 114 of the flash memory 106. The example authentication queue 114 of FIG. 1 stores update requests received during runtime or during the Post ExitPmAuth stage that are directed to authenticated variables of the authenticated variable store 112. That is, the example SCU 104 of FIG. 1 defers update requests directed to authenticated variables (e.g., UEFI authenticated variables stored in the authenticated variable store 112) received during runtime or during the Post ExitPmAuth stage. In the illustrated example of FIG. 1, deferring the update requests includes restricting the computing platform 100 from processing the update requests while in the runtime environment or during the Post ExitPmAuth mode. Instead, as part of a subsequent boot cycle of the computing platform 100, the example SCU 104 reads the update request(s) stored in the authentication queue (if any are present) and determines whether the update request(s) are authentic. For example, the authenticity of each update request is verified by analyzing the digital signature associated with the respective update request. As defined in the UEFI specification, update requests directed to authenticated variables need to be digitally signed with a verifiable signature before any changes can be made to the authenticated variables. The signature verification of the UEFI specification involves, for example, hashing algorithms and digital key lookups. In the illustrated example of FIG. 1, the UEFI verification procedures are performed on the update requests of the authentication queue 114 to determine whether the update requests are allowed to alter the contents of the authenticated variable store 112. If so, the example updater 124 of FIG. 1 executes the update requests to alter the authenticated variables. Otherwise, update requests that are not authentically signed (e.g., failed the UEFI verification procedures) are discarded by the example updater 124.

While an example manner of implementing the computing platform 100 has been illustrated in FIG. 1, one or more of the elements, processes and/or devices illustrated in FIG. 1 may be combined, divided, re-arranged, omitted, eliminated and/or implemented in any other way. Further, although in the illustrated example the example stage detector 120, the example restriction enforcer 122, the example updater 124 and/or, more generally, the example SCU 104 of FIG. 1 are implemented in firmware, the example stage detector 120, the example restriction enforcer 122, the example updater 124 and/or, more generally, the example SCU 104 of FIG. 1 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the system or apparatus claims of this patent are read to cover a purely software and/or firmware implementation, at least one of the example stage detector 120, the example restriction enforcer 122, the example updater 124 and/or, more generally, the example SCU 104 of FIG. 1 are hereby expressly defined to include a tangible computer readable storage medium such as a storage device (e.g., memory), an optical storage disc (e.g., a DVD, a CD, a Bluray disc), or flash memory storing the software and/or firmware. Further still, the example computing platform 100 of FIG. 1 may include one or more elements, processes and/or devices in addition to, or instead of, those illustrated in FIG. 1, and/or may include more than one of any or all of the illustrated elements, processes and devices.

FIG. 2 illustrates example operations of the example computing platform 100 of FIG. 1 when the example stage detector 120 of the SCU 104 determines that the computing platform 100 is in the Pre-ExitPmAuth stage. The example of FIG. 2 corresponds to, for example, a startup of the computing platform 100 from a restart or a powered down state. As described above, the example SCU 104 of FIG. 1 utilizes the Pre-ExitPmAuth stage to process the update requests of the authentication queue 114 that were redirected from a previous instance of the runtime environment and/or the previous instance of the Post ExitPmAuth stage. In the illustrated example, at the onset of the Pre-ExitPmAuth stage, the SCU 104 receives an interprocessor command (IPC) for a read 200 of the authentication queue 114. The example restriction enforcer 122 of the SCU 104 of FIG. 1 allows read access to the authentication queue 114 in the Pre-ExitPmAuth stage. Thus, a read 202 of the entire authentication queue 114 is performed.

The example of FIG. 2 illustrates a loop 204 executed by the example SCU 104 of FIG. 1 to process the update requests read from the authentication queue 114. In particular, the example SCU 104 attempts to verify the signature associated with a respective one of the update requests via a verification function 206. If the example verification function 206 indicates that the update request is authentic, the verification is considered to be a success 208 and the update request can be executed. In the illustrated example, for update requests that were successfully verified as authentic 208, the example SCU 104 receives a write request 210 representative of the verified update request. In response, the example updater 124 of FIG. 1 issues an update 212 (e.g., a write function) to alter the value of the corresponding authenticated variable in the authenticated variable store 112 according to the write request 210. Alternatively, if the example verification function 206 indicates that the update request is not authentic, the verification is considered to be a failure 214 and the update request is not processed. In particular, failed update requests are discarded via a discard function 216. In the example of FIG. 2, each update request stored in the authentication queue 114 is either executed (e.g., to update one or more of the UEFI authenticated variables of the authenticated variable store 112with new value(s)) or discarded (e.g., denied access to the authenticated variable store 112). When each of the update requests stored in the authentication queue 114 has been executed or discarded, the example queue is emptied via a delete function 218.

Thus, the update requests of the authentication queue 114, which were deferred from a previous runtime environment or a previous Post ExitPmAuth stage, are executed or discarded during the Pre-ExitPmAuth stage. As described above, the Pre-ExitPmAuth stage corresponds to the UEFI variable services not yet being active (e.g., not yet accessible by the OS 102) and the firmware associated with the SCU 104 and/or the flash memory 106 being isolated from the OS 102. Further, during the Pre-ExitPmAuth stage illustrated in FIG. 2, the example restriction enforcer 122 allows read/write/delete access to the contents of the other partitions of the flash memory 106 (e.g., the boot services variable store 116 and the runtime services variable store 118).

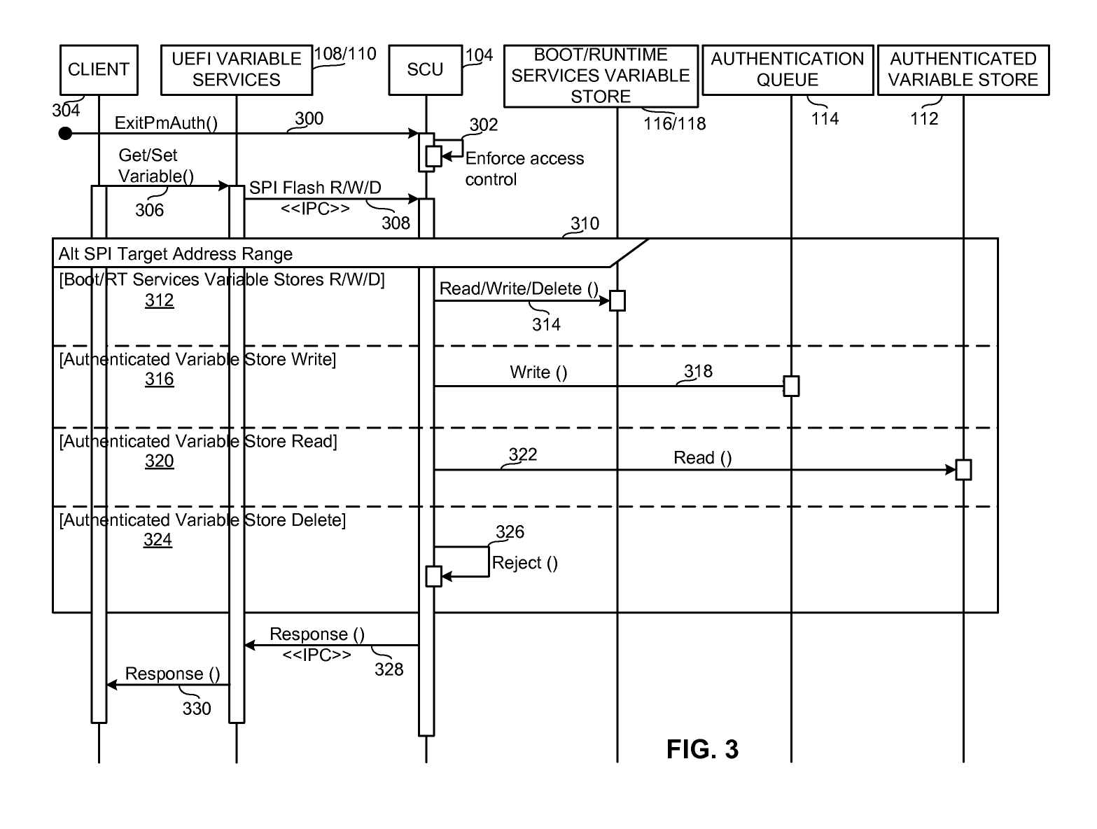

FIG. 3 illustrates example operations of the example computing platform 100 of FIG. 1 when the example stage detector 120 of the SCU 104 determines that the computing platform 100 is in the Post ExitPmAuth stage. In the illustrated example of FIG. 3, the computing platform 100 enters the Post ExitPmAuth stage after an ExitPmAuth function 300 is executed. When the example stage detector 120 of FIG. 1 determines that the computing platform 100 is in the Post ExitPmAuth stage, the restriction enforcer 122 of the example SCU 104 of FIG. 1 enforces the corresponding access controls 302 to the flash memory 106. In particular, the example restriction enforcer 122 of FIG. 1 provides read-only access to the authenticated variable store 112 during the Post ExitPmAuth stage. Further, the example restriction enforcer 122 of FIG. 1 provides read/write/delete access to the boot services variable store 116 and the runtime services variable store 118 during the Post ExitPmAuth stage.

The different restrictions enforced by the example restriction enforcer 122 of FIG. 1 during the Post ExitPmAuth depending on the type of access request are illustrated in FIG. 3. In the illustrated example, a client 304 (e.g., a BIOS component or a component of the OS 102) issues a request 306 to the UEFI variable services (e.g., the UEFI runtime variable services 108 or the UEFI boot variable services 110). The example request 306 of FIG. 3 may be a read, write, or delete request directed to the authenticated variable store 112, the boot services variable store 116 or the runtime services variable store 118. The type of the request (e.g., read, write, or delete) is apparent from the request and the partition of the flash memory 106 to which the request 306 is directed is identifiable from, for example, the target address range specified in parameters of the request 306. In response to the request 306, the example SCU 104 of FIG. 1 receives an IPC 308 representative of the request 306. The example restriction enforcer 122 of FIG. 1 determines the type of the IPC 308 and the partition of the flash memory 106 to which the IPC 308 is directed. In the illustrated example, the SCU 104 of FIG. 1 handles the IPC 308 depending on the determinations of the restriction enforcer 122.

The example of FIG. 3 includes a conditional diagram 310 including a plurality of portions, each corresponding to a different type or target of the IPC 308 received by the SCU 104. A first conditional portion 312 of FIG. 3 represents the restriction enforcer 122 determining that the IPC 308 corresponds to a read, write, or delete request directed to the boot services variable store 116 or the runtime services variable store 118. In such instances, the example SCU 104 of FIG. 1 conveys a corresponding read, write or delete request 314 to the appropriate one of the boot services variable store 116 or the runtime services variable store 118. Thus, when the received IPC 308 falls into the first conditional portion 312 of FIG. 3, the example SCU 104 of FIG. 1 grants the requested access and performs the requested function.

A second conditional portion 316 of FIG. 3 represents the restriction enforcer 122 determining that the IPC 308 corresponds to a write request directed to the authenticated variable store 112. As described above, such an update request is to be deferred until a subsequent boot cycle. Accordingly, when the received IPC 308 falls into the second conditional portion 316 of FIG. 3, the example SCU 104 denies (at least temporarily) access to the authenticated variable store 112 and conveys a write request 318 to the authentication queue 114. As described in connection with FIG. 2 above, the example write request 318 is processed (e.g., executed if verified as authentic, discarded if not authentic) the next time the computing platform 100 enters the Pre-ExitPmAuth stage.

A third conditional portion 320 of FIG. 3 represents the restriction enforcer 122 determining that the IPC 308 corresponds to a read request directed to the authenticated variable store 112. In such instances, the SCU 104 grants access to the authenticated variable store 112 and conveys a corresponding read request 322 to the authenticated variable store 112. A fourth conditional portion 324 of FIG. 3 represents the restriction enforcer 122 determining that the IPC 308 corresponds to a delete request directed to the authenticated variable store 112. In such instances, the SCU 104 denies access to the authenticated variables store 112 and issues a rejection instruction 326 to discard (e.g., erase and/or mark as discarded) the IPC 308. When the appropriate action has been taken by the SCU 104, the example SCU 104 conveys a response indication 328 to the requesting variable service 108/110 and the client 304 receives an acknowledgement 330.

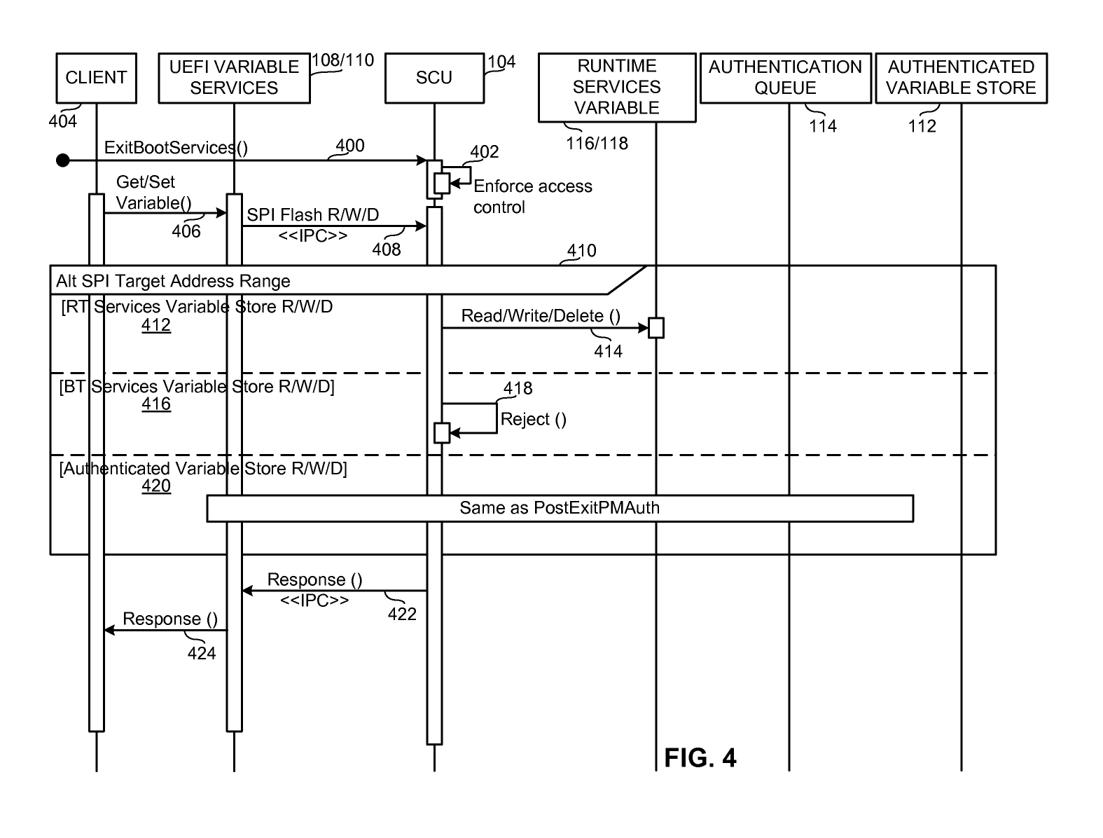

FIG. 4 illustrates example operations of the example computing platform 100 of FIG. 1 when the example stage detector 120 of the SCU 104 determines that the computing platform 100 is in a runtime environment (e.g., a stage occurring after the Post ExitPmAuth stage). In the illustrated example of FIG. 4, the runtime environment corresponds to a time after the computing platform 100 has been fully booted. In the example of FIG. 4, issuance of a boot exit function 400 represents the computing platform 100 entering the runtime environment. When the example stage detector 120 of FIG. 1 determines that the computing platform 100 is in the runtime environment, the restriction enforcer 122 of the example SCU 104 of FIG. 1 enforces the corresponding access controls 402 to the flash memory 106. In particular, the example restriction enforcer 122 of FIG. 1 provides read-only access to the authenticated variable store 112 during the runtime environment. Further, the example restriction enforcer 122 of FIG. 1 provides read/write/delete access to the runtime services variable store 118 during the runtime environment. Further, the example restriction enforcer 122 of FIG. 1 denies access to the boot services variable store 116 during the runtime environment.

The different restrictions enforced by the example restriction enforcer 122 of FIG. 1 during the runtime environment depending on the type of access request are illustrated in FIG. 4. In the illustrated example, a client 404 (e.g., a component of the OS 102) issues a request 406 to the UEFI variable services (e.g., the UEFI runtime variable services 108 or the UEFI boot variable services 110). The example request 406 of FIG. 4 may be a read, write, or delete request directed to the authenticated variable store 112, the boot services variable store 116 or the runtime services variable store 118. The type of the request (e.g., read, write, or delete) is apparent from the request. The partition of the flash memory 106 to which the request 406 is directed is identifiable from, for example, the target address range specified in parameters of the request 406. In response to the request 406, the example SCU 104 of FIG. 1 receives an IPC 408 representative of the request 406. The example restriction enforcer 122 of FIG. 1 determines the type of the IPC 408 and the partition of the flash memory 106 to which the IPC 408 is directed. In the illustrated example, the SCU 104 of FIG. 1 handles the IPC 408 in accordance with the determinations of the restriction enforcer 122.

The example of FIG. 4 includes a conditional diagram 410 including a plurality of portions, each corresponding to a different type or target of the IPC 408 received by the SCU 104. A first conditional portion 412 of FIG. 4 represents the restriction enforcer 122 determining that the IPC 408 corresponds to a read, write, or delete request directed to the runtime services variable store 118. In such instances, the example SCU 104 of FIG. 1 conveys a corresponding read, write or delete function 414 to the runtime services variable store 118. Thus, when the received IPC 408 falls into the first conditional portion 412 of FIG. 4, the example SCU 104 of FIG. 1 grants the requested access and facilitates the requested function.

A second conditional portion 416 of FIG. 4 represents the restriction enforcer 122 determining that the IPC 408 corresponds to a read, write or delete request directed to the boot services variable store 116. In such instances, the example SCU 104 denies access to the boot services variable store 116 and executes a rejection function 418.

A third conditional portion 420 of FIG. 4 represents the restriction enforcer 122 determining that the IPC 408 corresponds to a read, write or delete request directed to the authenticated variable store 112. In such instances, the SCU 104 handles the IPC 408 in a similar manner as described above in connection with FIG. 3, which corresponds to the Post ExitPmAuth stage. In other words, the third conditional portion 420 of FIG. 4 is the same as the second, third and fourth conditional portions 316, 320 and 324 of FIG. 3. That is, when the IPC 408 falls in the third conditional portion 420 of FIG. 4, the example SCU 104 of FIG. 1 grants access to the authenticated variable store 112 for read requests, defers write requests by storing the same in the authentication queue 114, and rejects (e.g., discards) delete requests. When the appropriate action has been taken by the SCU 104, the example SCU 104 conveys a response indication 422 to the requesting variable service 108/110 and the client 404 receives an acknowledgement 424.

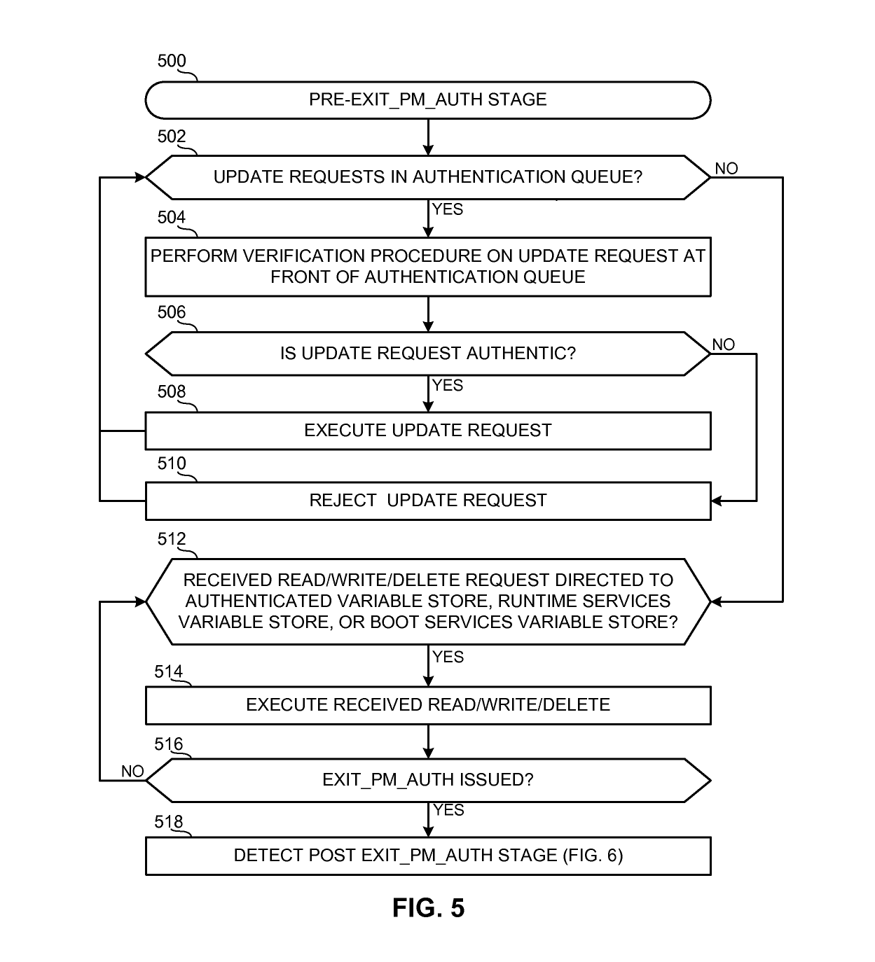

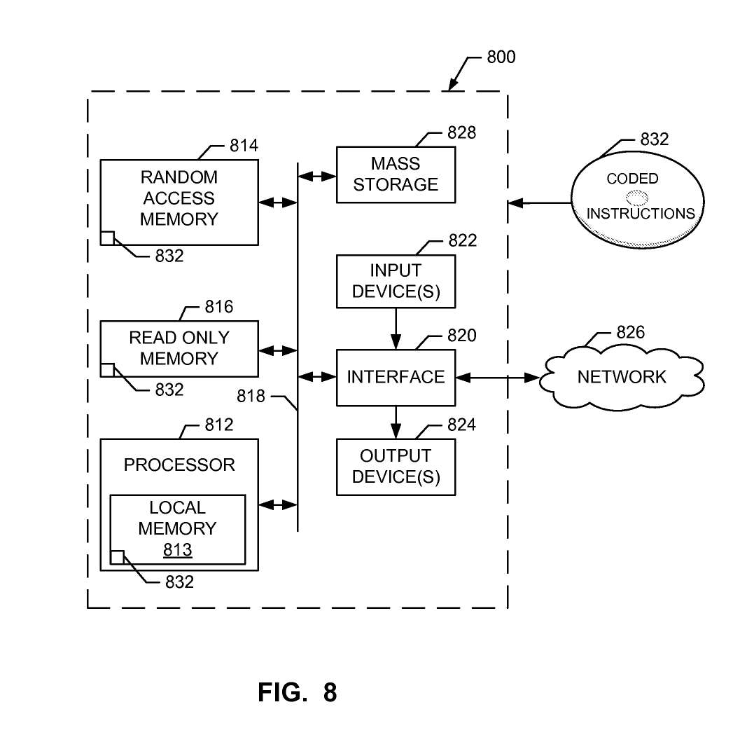

FIGS. 5-7 are flowcharts representative of example machine readable instructions for implementing the example SCU 104 of FIG. 1. In the example flowcharts of FIGS. 5-7, the machine readable instructions comprise program(s) for execution by a processor such as the processor 812 shown in the example platform 800 discussed below in connection with FIG. 8. The program(s) may be embodied in, for example, instructions (e.g., firmware, software, etc.) stored on a tangible computer readable storage medium such as flash memory, a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in dedicated hardware. Further, although the example program(s) is described with reference to the flowcharts illustrated in FIGS. 5-7, many other methods of implementing the example SCU 104 may alternatively be used. For example, the order of execution of the blocks may be changed, and/or some of the blocks described may be changed, eliminated, or combined.

As mentioned above, the example processes of FIGS. 5-7 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage medium in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disc and to exclude propagating signals. Additionally or alternatively, the example processes of FIGS. 5-7 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage medium in which information is stored for any duration (e.g., for extended time periods, permanently, brief instances, for temporarily buffering, and/or for caching of the information). As used herein, the term non-transitory computer readable storage medium is expressly defined to include any type of computer readable storage device or storage disc and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 5 begins with the stage updater 120 determining that the example computing platform 100 of FIG. 1 is in the Pre-ExitPmAuth stage (block 500). When the authentication queue 114 of the flash memory 106 includes one or more update requests (e.g., write requests received during a previous runtime environment) (block 502), the authenticity of the update request at the front of the authentication queue 114 is determined (e.g., via a check of the corresponding digital signature) (block 504). When the update request is authentic (block 506), the example updater 124 of the SCU 104 executes the requested update (e.g., write function) (block 508). When the update request is not authentic (block 506), the example updater 124 of the SCU 104 rejects the update request without performing the requesting update (block 510). Control then returns to block 502 to determine whether the authentication queue 114 includes additional update request(s).

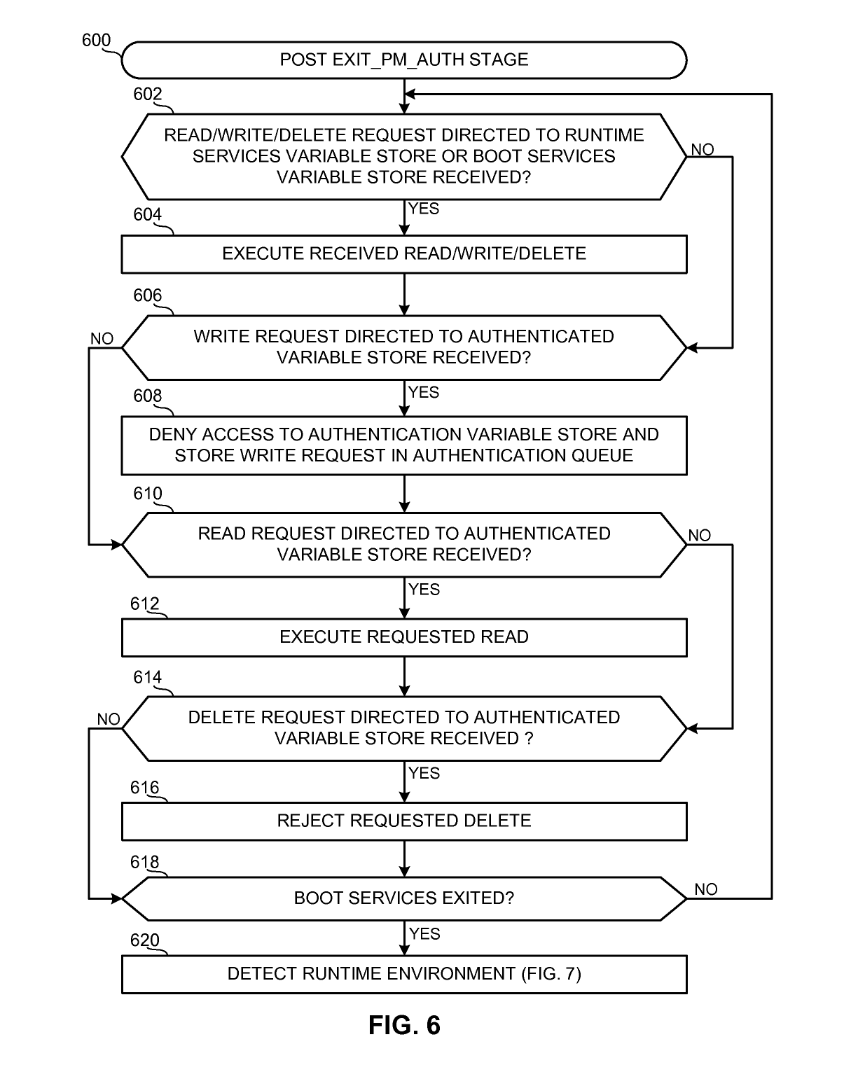

If the authentication queue 114 is empty (block 502), the example SCU 104 determines whether a read, write, or delete request directed to any of the authenticated variable store 112, the runtime services variable store 116, or the boot services variable store 118 has been received (block 512). If such a read/write/delete request is received (block 512), the updater 124 of the SCU 104 executes the received read/write/delete request (block 514). The example stage detector 120 of the SCU 104 determines whether the ExitPmAuth command has been issued, thereby indicating that the computing platform 100 is exiting the Pre-ExitPmAuth stage and entered the Post ExitPmAuth stage (block 516). If so, the example of FIG. 5 ends and control proceeds to FIG. 6 (block 518).

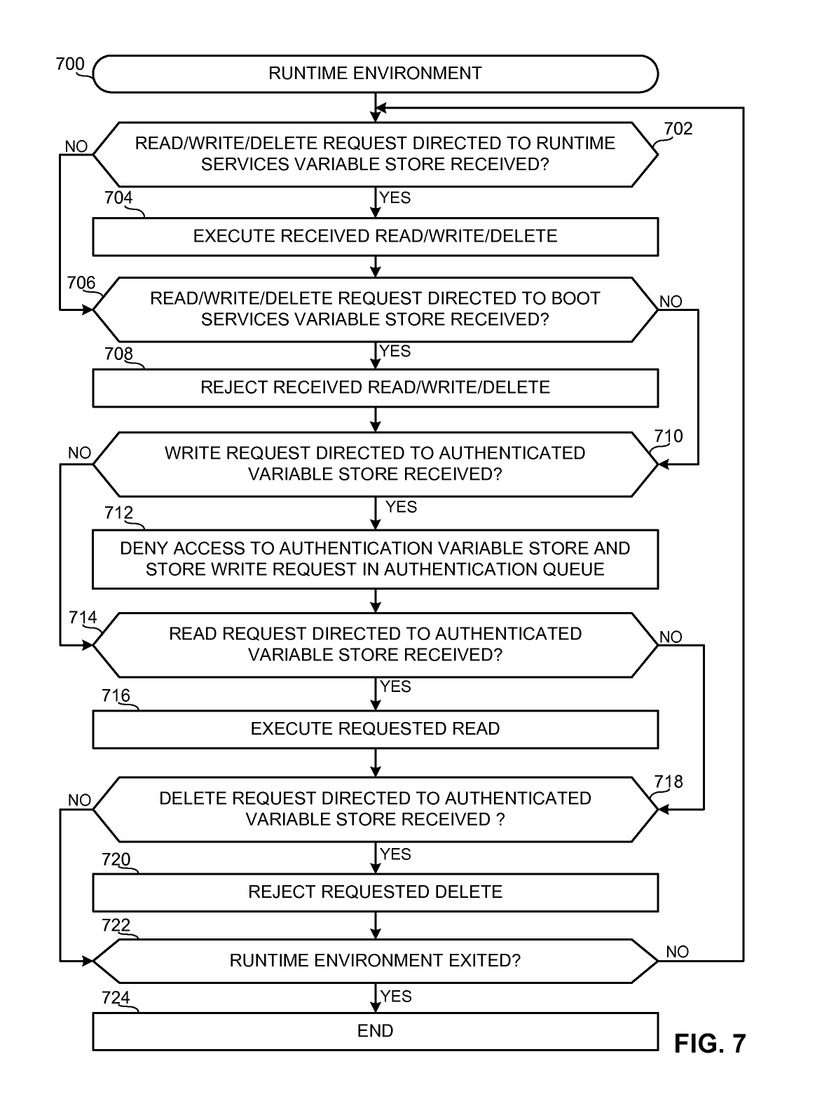

FIG. 6 begins with the stage updater 120 determining that the example computing platform 100 of FIG. 1 is in the Post ExitPmAuth stage (block 600). In the example of FIG. 6, when the example SCU 104 receives a read, write, or delete request directed to the runtime services variable store 118 or the boot services variable store 116 of the flash memory 106 (block 602), the example restriction enforcer 122 of the SCU 104 allows access to the targeted one of the variable stores 116, 118 and the requested read, write, or delete is executed (block 604). In the example of FIG. 6, when the example SCU 104 receives a write request directed to the authenticated variable store 116 (block 606), the example restriction enforcer 122 of the SCU 104 denies access to the authentication variable store 106 and the write request is stored in the authentication queue 114 (block 608). In the example of FIG. 6, when the example SCU 104 receives a read request directed to the authenticated variable store 116 (block 610), the example restriction enforcer 122 of the SCU 104 allows access to the authentication variable store 106 and the requested read is executed (block 612). In the example of FIG. 6, when the example SCU 104 receives a delete request directed to the authenticated variable store (block 614), the example restriction enforcer 122 denies access to the authentication queue 114 and the delete request is rejected (block 616). If the boot services of the example computing platform 100 are exited (block 618), the example stage detector 120 determines that the computing platform 100 is entering the runtime environment and control proceeds to FIG. 7 (block 620).

FIG. 7 begins with the stage updater 120 determining that the example computing platform 100 of FIG. 1 is in the runtime environment (block 700). In the example of FIG. 7, when the example SCU 104 receives a read, write, or delete request directed to the runtime services variable store 118 of the flash memory 106 (block 702), the example restriction enforcer 122 of the SCU 104 allows access to the runtime services variable store 118 and the requested read, write, or delete is executed (block 704). In the example of FIG. 7, when the example SCU 104 receives a read, write, or delete request directed to the boot services variable store 116 of the flash memory 106 (block 706), the example restriction enforcer 122 of the SCU 104 denies access to the boot services variable store 116 and the requested read, write, or delete is rejected (block 708). In the example of FIG. 7, when the example SCU 104 receives a write request directed to the authenticated variable store 116 (block 7710), the example restriction enforcer 122 of the SCU 104 denies access to the authentication variable store 106 and the write request is stored in the authentication queue 114 (block 712). In the example of FIG. 7, when the example SCU 104 receives a read request directed to the authenticated variable store 116 (block 714), the example restriction enforcer 122 of the SCU 104 allows access to the authentication variable store 106 and the requested read is executed (block 716). In the example of FIG. 7, when the example SCU 104 receives a delete request directed to the authenticated variable store (block 718), the example restriction enforcer 122 denies access to the authentication queue 114 and the delete request is rejected (block 716). If the runtime environment of the example computing platform 100 is exited (block 722), the example of FIG. 7 ends (block 724).

FIG. 8 is a block diagram of a processor platform 800 capable of executing the instructions of FIGS. 5-7 to implement the example SCU 104 of FIG. 1. The processor platform 800 can be, for example, a small core computing platform implemented on a tablet, a mobile phone, a microcontroller, a DVD player, a CD player, a Blu-ray player, a gaming console, or any other type of computing device.

The processor platform 800 of the instant example includes a processor 812. For example, the processor 812 can be implemented by one or more microprocessors or controllers from any desired family or manufacturer.

The processor 812 includes a local memory 813 (e.g., a cache) and is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. The instructions represented by FIGS. 5-7 may be stored in the non-volatile memory 816 as firmware. Access to the main memory 814, 816 is controlled by a memory controller.

The processor platform 800 also includes an interface circuit 820. The interface circuit 820 may be implemented by any type of interface standard, such as an Ethernet interface, a universal serial bus (USB), and/or a PCI express interface.

One or more input devices 822 are connected to the interface circuit 820. The input device(s) 822 permit a user to enter data and commands into the processor 812. The input device(s) can be implemented by, for example, a keyboard, a mouse, a touchscreen, a track-pad, a trackball, isopoint and/or a voice recognition system.

One or more output devices 824 are also connected to the interface circuit 820. The output devices 824 can be implemented, for example, by display devices (e.g., a liquid crystal display, a cathode ray tube display (CRT), a printer and/or speakers). The interface circuit 820, thus, typically includes a graphics driver card.

The interface circuit 820 also includes a communication device such as a modem or network interface card to facilitate exchange of data with external computers via a network 826 (e.g., an Ethernet connection, a digital subscriber line (DSL), a telephone line, coaxial cable, a cellular telephone system, etc.).

The processor platform 800 also includes one or more mass storage devices 828 for storing software and data. Examples of such mass storage devices 828 include floppy disk drives, hard drive disks, compact disk drives and digital versatile disk (DVD) drives.

Coded instructions 832, such as the example machine readable instructions of FIGS. 5, 6 and/or 7 may be stored in the mass storage device 828, in the volatile memory 814, in the non-volatile memory 816, and/or on a removable storage medium such as a CD or DVD. As mentioned above, examples that implement the instructions of FIGS. 5-7 as firmware locate the instructions in the non-volatile memory 816.

Example methods include, in response to an update request directed to an authenticated variable of a computing platform and received during a second stage of a first instance of a booting process, the booting process including a first stage and the second stage, restricting the update request from accessing the authenticated variable during the second stage of the first instance of the booting process and storing the update request in a queue.

Some example methods further include, in response to the computing platform entering a second instance of the booting process, verifying an authenticity of the update request of the queue during the first stage of the second instance of the booting process and, when the update request is authentic, executing the update request during the first stage of the second instance of the booting cycle.

Some example methods further include rejecting the update request during the first stage of the second instance of the booting process when the update request is not authentic.

In some example methods, the first instance of the booting process is prior to the second instance of the booting process.

In some example methods, the first stage of the booting process cycle is isolated from an operating system of the computing platform.

Some example methods further include, in response to a second update request directed to the authenticated variable and received during runtime of the computing platform, restricting the second update request from accessing the authenticated variable during the runtime and storing the second update request in the queue.

Some example methods further include, in response to the computing platform entering a second instance of the booting process verifying an authenticity of the second update request of the queue during the first stage of the second instance of the booting process and when the second update request is authentic, executing the second update request during the first stage of the second instance of the booting cycle.

In some example methods, the first stage of the booting process and the second stage of the booting process are divided by issuance of a command associated with an exit from a privileged mode of a pre-boot environment.

In some example methods, the authenticated variable is a Unified Extensible Firmware Interface (UEFI) authenticated variable.

Example tangible machine readable storage media include instructions that, when executed, cause a machine to, in response to an update request directed to an authenticated variable of a computing platform and received during a second stage of a first instance of a booting process, the booting process including a first stage and the second stage, restrict the update request from accessing the authenticated variable during the second stage of the first instance of the booting process and store the update request in a queue.

In some examples of the tangible machine readable storage media, the instructions cause the machine to, in response to the computing platform entering a second instance of the booting process, verify an authenticity of the update request of the queue during the first stage of the second instance of the booting process and when the update request is authentic, execute the update request during the first stage of the second instance of the booting cycle.

In some examples of the tangible machine readable storage media, the instructions cause the machine to reject the update request during the first stage of the second instance of the booting process when the update request is not authentic.

In some examples of the tangible machine readable storage media, the first instance of the booting process is prior to the second instance of the booting process.

In some examples of the tangible machine readable storage media, the first stage of the booting process cycle is isolated from an operating system of the computing platform.

In some examples of the tangible machine readable storage media, the instructions cause the machine to, in response to a second update request directed to the authenticated variable and received during runtime of the computing platform, restrict the second update request from accessing the authenticated variable during the runtime and store the second update request in the queue.

In some examples of the tangible machine readable storage media, the instructions cause the machine to, in response to the computing platform entering a second instance of the booting process, verify an authenticity of the second update request of the queue during the first stage of the second instance of the booting process and, when the second update request is authentic, execute the second update request during the first stage of the second instance of the booting cycle.

Example apparatus include a controller to restrict processing of an update request directed to an authenticated variable of a computing platform received during a second stage of a first booting process, the first booting process including a first stage and the second stage; a queue to store the update request received during the second stage of the first booting process; and an updater to process the update request during the first stage of a second booting process.

In some example apparatus, the controller is implemented via firmware, and the queue is implemented via flash memory.

In some example apparatus, the first booting process is prior to the second booting process.

In some example apparatus, the first stage and the second stage are divided by issuance of a command associated with an exit from a privileged mode of a pre-boot environment.

Example methods include processing entries of an authentication queue during a first stage of a boot cycle of a computing platform, wherein the computing platform is isolated from an operating system during the first stage of the boot cycle, and wherein the boot cycle includes a second stage in which the computing platform is exposed to the operating system; storing update requests received during the second stage of the boot cycle in the authentication queue and restricting processing of the update requests received during the second stage of the boot cycle; and storing update requests received during a runtime stage of the computing platform in the authentication queue and restricting processing of the update requests received during the runtime stage of the computing platform.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

1. A method, comprising:
in response to an update request directed to an authenticated variable of a computing platform and received during a second stage of a first instance of a booting process, the booting process including a first stage and the second stage:
restricting the update request from accessing the authenticated variable during the second stage of the first instance of the booting process; and
storing the update request in a queue.

2. A method as defined in claim 1, further comprising, in response to the computing platform entering a second instance of the booting process:
verifying an authenticity of the update request of the queue during the first stage of the second instance of the booting process; and
when the update request is authentic, executing the update request during the first stage of the second instance of the booting cycle.

3. A method as defined in claim 2, further comprising rejecting the update request during the first stage of the second instance of the booting process when the update request is not authentic.

4. A method as defined in claim 2, wherein the first instance of the booting process is prior to the second instance of the booting process.

5. A method as defined in claim 2, wherein the first stage of the booting process cycle is isolated from an operating system of the computing platform.

6. A method as defined in claim 1, further comprising:
in response to a second update request directed to the authenticated variable and received during runtime of the computing platform:
restricting the second update request from accessing the authenticated variable during the runtime; and
storing the second update request in the queue.

7. A method as defined in claim 6, further comprising, in response to the computing platform entering a second instance of the booting process:
verifying an authenticity of the second update request of the queue during the first stage of the second instance of the booting process; and
when the second update request is authentic, executing the second update request during the first stage of the second instance of the booting cycle.

8. A method as defined in claim 1, wherein the first stage of the booting process and the second stage of the booting process are divided by issuance of a command associated with an exit from a privileged mode of a pre-boot environment.

9. A method as defined in claim 1, wherein the authenticated variable is a Unified Extensible Firmware Interface (UEFI) authenticated variable.

10. A tangible machine readable storage medium comprising instructions that, when executed, cause a machine to at least:
in response to an update request directed to an authenticated variable of a computing platform and received during a second stage of a first instance of a booting process, the booting process including a first stage and the second stage:
restrict the update request from accessing the authenticated variable during the second stage of the first instance of the booting process; and
store the update request in a queue.

11. A tangible machine readable storage medium as defined in claim 10, wherein the instructions cause the machine to, in response to the computing platform entering a second instance of the booting process:
verify an authenticity of the update request of the queue during the first stage of the second instance of the booting process; and
when the update request is authentic, execute the update request during the first stage of the second instance of the booting cycle.

12. A tangible machine readable storage medium as defined in claim 11, wherein the instructions cause the machine to reject the update request during the first stage of the second instance of the booting process when the update request is not authentic.

13. A tangible machine readable storage medium as defined in claim 11, wherein the first instance of the booting process is prior to the second instance of the booting process.

14. A tangible machine readable storage medium as defined in claim 11, wherein the first stage of the booting process cycle is isolated from an operating system of the computing platform.

15. A tangible machine readable storage medium as defined in claim 10, wherein the instructions cause the machine to:
in response to a second update request directed to the authenticated variable and received during runtime of the computing platform:
restrict the second update request from accessing the authenticated variable during the runtime; and
store the second update request in the queue.

16. A tangible machine readable storage medium as defined in claim 15, wherein the instructions cause the machine to, in response to the computing platform entering a second instance of the booting process:
verify an authenticity of the second update request of the queue during the first stage of the second instance of the booting process; and
when the second update request is authentic, execute the second update request during the first stage of the second instance of the booting cycle.

17. An apparatus, comprising:
a controller to restrict processing of an update request directed to an authenticated variable of a computing platform received during a second stage of a first booting process, the first booting process including a first stage and the second stage;
a queue to store the update request received during the second stage of the first booting process; and
an updater to process the update request during the first stage of a second booting process.

18. An apparatus as defined in claim 17, wherein the controller is implemented via firmware, and the queue is implemented via flash memory.

19. An apparatus as defined in claim 17, wherein the first booting process is prior to the second booting process.

20. An apparatus as defined in claim 17, wherein the first stage and the second stage are divided by issuance of a command associated with an exit from a privileged mode of a pre-boot environment.

21. (canceled)
